(19) United States
(12) Patent Application Publication
(10) Pub. No.: US 2013/0241322 A1
(43) Pub. Date: Sep. 19, 2013

(54) LINEAR VIBRATOR

(71) Applicant: CRESYN CO., LTD., Seoul (KR)

(72) Inventors: Jong-Bae LEE, Seoul (KR); Sung-Soo LEE, Cheongju-si (KR); Min-Su JOO, Seoul (KR)

(73) Assignee: CRESYN CO., LTD., Seoul (KR)

(21) Appl. No.: 13/826,170

(22) Filed: Mar. 14, 2013

(30) Foreign Application Priority Data
Mar. 16, 2012 (KR) 10-2012-0027385
Feb. 22, 2013 (KR) 10-2013-0018975

(51) Int. Cl. H02K 33/00

(52) U.S. Cl. CPC H02K 33/00
USPC 310/25

(57) ABSTRACT

A linear vibrator being used in a mobile phone is provided. The linear vibrator includes a ring-shape permanent magnet in the outside of a cylindrical coil, and the poles of the permanent magnet are divided into the inside of the permanent magnet facing the coil and the outside of the permanent magnet in a direction opposite to the inside of the permanent magnet. Accordingly, efficiency can be improved, a size can be reduced, and productivity and durability can be improved.

### PRIORITY

This application claims the benefit under 35 U.S.C. §119(a) of a Korean patent application filed on Mar. 16, 2012 in the Korean Intellectual Property Office and assigned Serial No. 10-2012-0027385 and a Korean patent application filed on Feb. 22, 2013 in the Korean Intellectual Property Office and assigned Serial No. 10-2013-0018975, the entire disclosure of each of which is hereby incorporated by reference.

### BACKGROUND OF THE INVENTION

1. Field of the Invention

The present invention relates to a linear vibrator used in a mobile phone. 2. Description of the Related Art

With the popularization of a mobile phone, a new type of a received alarm method called vibration has been created by incoming call pollution. This new type of a received alarm method is implemented by technology in which a user is informed of an incoming call by generating vibration when an electric current is supplied to a vibrator.

Meanwhile, the first vibrator adopted a method of generating vibration by rotating an eccentric mass body using a motor. However, a technical object, that is, a reduced size and thinness closely related to portability, has been further advanced from the generation of vibration by rotation and thus has derived technology regarding a vibrator that linearly vibrates. In particular, technology in which vibration is generated in order to inform that a touch has been made is applied to a recent touch phone. In this case, a linear vibrator must be used because a reaction to vibration needs to be rapidly performed. An example of the linear vibrator can include Korean Patent Registration No. 10-1046044 entitled Linear Vibrator.

In prior arts, the poles of a permanent magnet are differently disposed in a direction in which vibration is generated and a magnetic flux is also made close to a coil by way of a plate made of a magnetic material in order to improve efficiency. In the prior arts, however, since the direction coupling both poles of the permanent magnet together is basically vertical to a direction toward the coil, some of the magnetic flux generated from the permanent magnet leaks without interfering with the magnetic flux of the coil, thereby not contributing to the vibration of the permanent magnet. This restricts the improvement of efficiency and becomes a stumbling block to a reduction in the size of a linear vibrator.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide technology regarding a linear vibrator in which a direction coupling both poles of a permanent magnet together is disposed in a direction toward a coil.

In accordance with an aspect of the present invention, a linear vibrator is provided. The linear vibrator includes a cylindrical coil provided in the central portion of the linear vibrator and configured to generate a magnetic flux in response to an electrical signal, a permanent magnet configured in a ring shape in the outside of the coil and configured to vibrate in response to the magnetic flux generated from the coil, a vibration body coupled with the outside of the permanent magnet and configured to vibrate while operating in conjunction with the vibration of the permanent magnet, a casing configured to accommodate the coil, the permanent magnet, and the vibration body, a circuit board configured to supply the electrical signal to the coil, and a spring configured to elastically support the vibration body to the casing, wherein the inside of the permanent magnet facing the coil and the outside of the permanent magnet coming into contact with the vibration body have different poles.

The linear vibrator preferably may further include a fixing body made of a non-magnetic material and configured to fix the permanent magnet to the vibration body.

The linear vibrator preferably may further include a polepiece inserted into the inside of the coil in order to concentrate the magnetic flux on the inside of the coil.

The permanent magnet preferably may be split into two or more pieces when being seen in the vibration direction of the permanent magnet.

The vibration body preferably may include a support jaw for supporting a first end of the permanent magnet, and a second end of the permanent magnet may be supported by the spring.

The casing may include an upper casing and a lower casing coupled with the upper casing, wherein a first fixing hole into and to which the upper part of the polepiece is inserted and fixed is formed in the upper casing, and a second fixing hole into and to which the lower part of the polepiece is inserted and fixed is formed in the lower casing.

In accordance with another aspect of the present invention, a linear vibrator is provided. The linear vibrator includes a cylindrical coil provided in the central portion of the linear vibrator and configured to generate a magnetic flux in response to an electrical signal, a permanent magnet configured in a ring shape in the outside of the coil and configured to vibrate in response to the magnetic flux generated from the coil, a vibration body coupled with the outside of the permanent magnet and configured to vibrate while operating in conjunction with the vibration of the permanent magnet, a casing configured to accommodate the coil, the permanent magnet, and the vibration body, a circuit board configured to supply the electrical signal to the coil, and a spring configured to elastically support the vibration body to the casing, wherein the vibration body comprises a support jaw for supporting a first end of the permanent magnet, and a second end of the permanent magnet is supported by the spring.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a schematic exploded perspective view showing a linear vibrator according to a first exemplary embodiment of the present invention;

FIG. 2 is a schematic assembly cross-sectional view showing the linear vibrator of FIG. 1 according to an exemplary embodiment of the present invention;

FIG. 3 is a plan view of a permanent magnet applied to the linear vibrator of FIG. 1 which is seen in the vibration direction of the permanent magnet according to an exemplary embodiment of the present invention;

FIG. 4 is a schematic assembly cross-sectional view showing a linear vibrator according to another exemplary embodiment of the present invention in which a direction in which a spring is disposed is different from that of FIG. 1;

FIGS. 5 and 6 are reference diagrams illustrating the operation of the linear vibrator of FIG. 1 according to an exemplary embodiment of the present invention;

FIG. 7 is a schematic exploded perspective view showing a linear vibrator according to a second exemplary embodiment of the present invention; and

FIG. 8 is a schematic assembly cross-sectional view showing the linear vibrator of FIG. 7 according to an exemplary embodiment of the present invention.

Throughout the drawings, it should be noted that like reference numbers are used to depict the same or similar elements, features, and structures.

### DESCRIPTION OF REFERENCE NUMERALS OF PRINCIPAL ELEMENTS IN THE DRAWINGS

| | |
|---|---|
| 100, 700: linear vibrator | 110, 710: coil |
| 120, 720: permanent magnet | 130: fixing body |
| 140, 740: polepiece | 150, 750: vibration body |
| 751: support jaw | 160, 760: spring |
| 170, 770: damper | 180, 780: casing |
| 181, 781: upper casing | 182, 782: lower casing |
| 781a: first fixing hole | 782a: second fixing hole |
| 190, 790: circuit board | |

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

### First Exemplary Embodiment

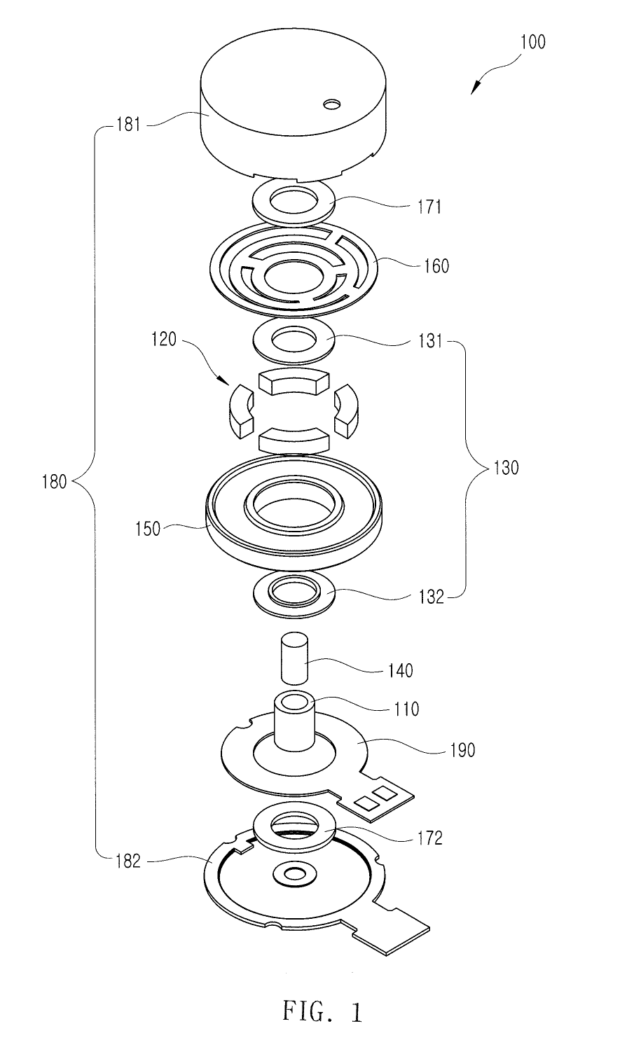

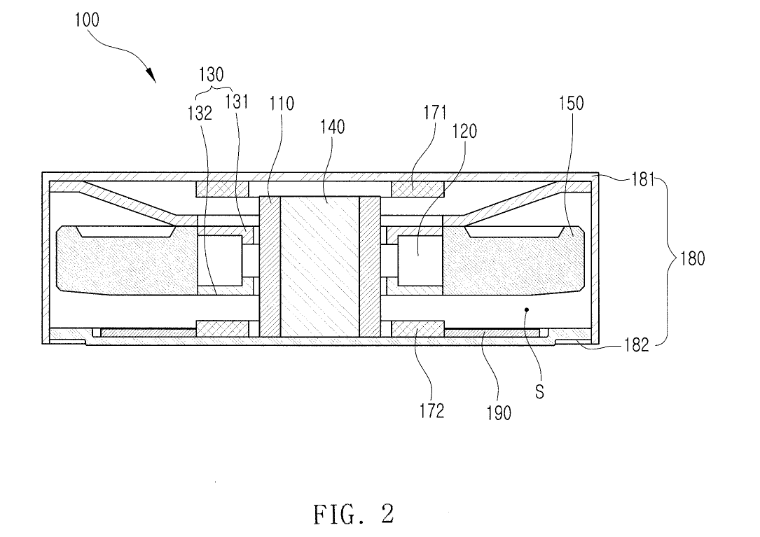

FIGS. 1 and 2 are a schematic exploded perspective view and schematic assembly cross-sectional view of a linear vibrator 100 according to a first exemplary embodiment of the present invention.

Referring to FIGS. 1 and 2, the linear vibrator 100 according to an exemplary embodiment of the present invention includes a coil 110, a permanent magnet 120, a fixing body 130, a polepiece 140, a vibration body 150, a spring 160, dampers 171 and 172, a casing 180, and a circuit board 190.

The coil 110 having a cylindrical solenoid form is provided in the central portion of the linear vibrator 100 and is configured to generate a magnetic flux in response to an electrical signal generated from the circuit board 190.

The permanent magnet 120 has a ring shape having a hole formed in the center thereof, and the coil 110 is inserted into the hole of the permanent magnet 120. That is, the permanent magnet 120 is disposed in the outside of the coil 110 and is configured to vibrate up and down in response to the magnetic flux generated from the coil 110.

Here, the outside of the permanent magnet 120 configured to come into contact with the vibration body 150 and placed in a direction opposite to the inside of the permanent magnet 120 that faces the coil 110 and the inside of the permanent magnet 120 have different poles. Accordingly, a direction coupling both poles of the permanent magnet 120 together is directed toward the coil 110, so the magnetic flux generated from the permanent magnet 120 has directivity directly toward the coil 110.

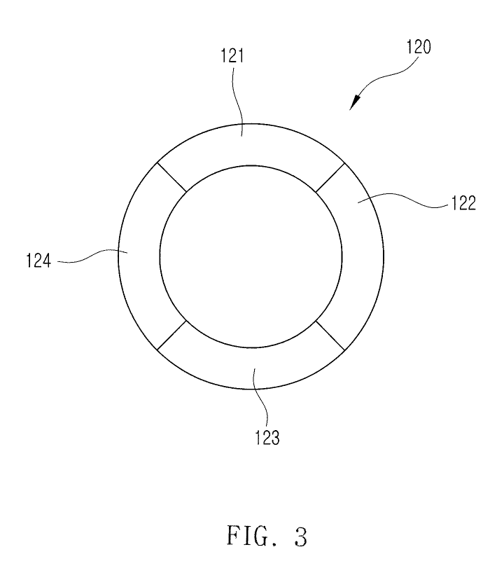

Referring to FIG. 1 and FIG. 3 showing the permanent magnet 110 seen in a vibration direction thereof, the permanent magnet 110 is split into four pieces 121 to 124. Accordingly, the permanent magnet 110 can be easily manufactured as compared with a case where the entire ring-shaped permanent magnet is magnetized. In some exemplary embodiments, the permanent magnet may be formed of only one piece or may be formed of 2 pieces, 3 pieces, or 5 or more pieces.

The fixing body 130 is made of a non-magnetic material and is configured to fix the permanent magnet 120 to the vibration body 150. The fixing body 130 can be divided into an upper part 131 and a lower part 132 facing the upper part 131. Furthermore, the fixing body 130 also functions to maintain the arrangement of the 4 pieces 121 to 124 of the permanent magnet 120.

The polepiece 140 is made of a magnetic material and is configured in a cylindrical shape. The polepiece 140 is inserted into the inside of the coil 110 and is configured to concentrate the magnetic flux of the permanent magnet 120 on the inside of the coil 110.

The vibration body 150 has a hole formed in the center thereof. The vibration body 150 is coupled with the outside of the permanent magnet 120, that is, the permanent magnet 120 is inserted into the hole of the vibration body 150. Accordingly, the vibration body 150 is vibrated while operating in conjunction with the vibration of the permanent magnet 120, thus increasing a vibration mass.

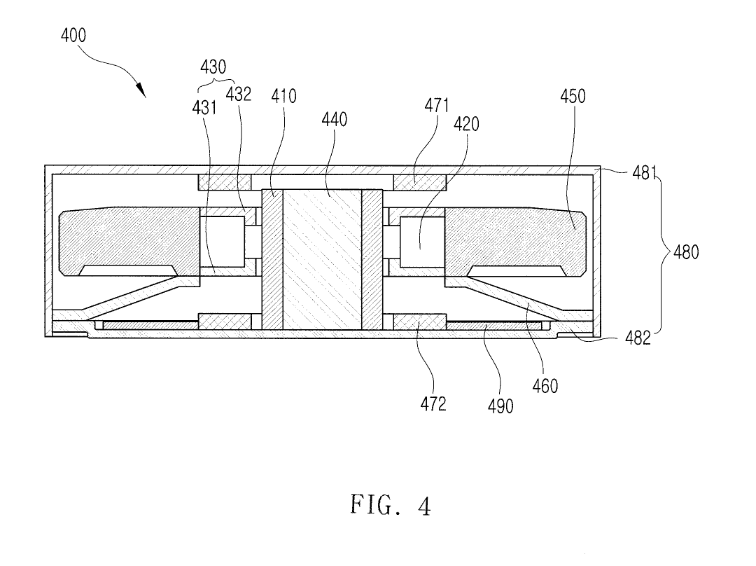

The spring 160 provides elastic force for restoring the locations of the permanent magnet 120 and the vibration body 150 by elastically supporting the vibration body 150 that vibrates up and down and also prevents the permanent magnet 120 and the vibration body 150 from colliding against the top and bottom of the casing 180 by limiting the up and down vibration width of the permanent magnet 120 and the vibration body 150. To this end, the spring 160 has the top fixed to the casing 180 and bottom fixed to the vibration body 150. In another exemplary embodiment, a spring 460 may be provided under a vibration body 450, as shown in FIG. 4.

The dampers 171 and 172 are made of a ring-shaped cushion material and are configured to prevent some of vibrating parts (i.e., the permanent magnet 120, the fixing body 130, the vibration body 150, and the spring 160) from directly coming into contact with the top or bottom of the casing 180.

The casing 180 includes a receiving space S for accommodating the coil 110, the permanent magnet 120, the fixing body 130, the polepiece 140, the vibration body 150, the spring 160, and the dampers 171 and 172. The casing 180 can be separated into an upper casing 181 and a lower casing 182 coupled with the upper casing 181. The casing 180 can be made of a magnetic material in order to improve efficiency by further precluding an external leakage of the magnetic flux.

The circuit board 190 is provided to come in contact with the bottom of the casing 180 in order to input an electrical signal to the coil 110 and is formed in a ring shape. Accordingly, an upper and lower thickness of the linear vibrator 100 can be reduced because the bottom of the coil 110 is directly brought in contact with the bottom of the casing 180 and fixed thereto.

An operation of the linear vibrator 100 configured as described above is described below.

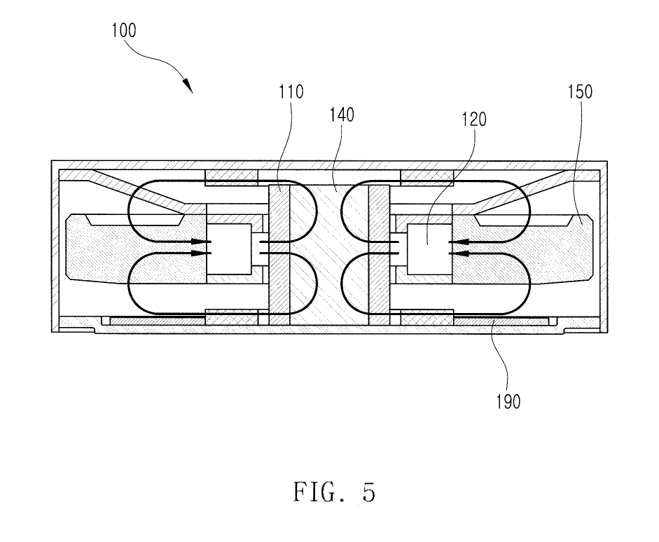

For example, a magnetic flux generated from the permanent magnet 120 is inputted to the polepiece 140 through the coil 110 and is then divided into up and down parts and rotated, as shown in FIG. 5.

Meanwhile, when an electrical signal generated from the circuit board 190 is inputted to the coil 110, an electric current flows through the coil 110.

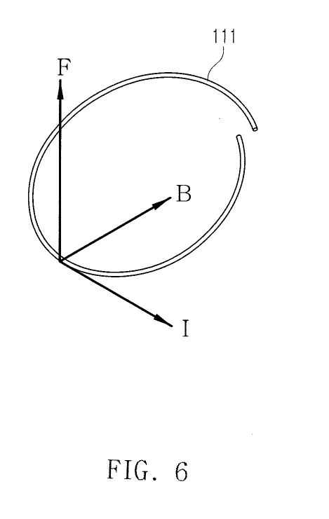

When one of threads 111 wound on the coil 110 is taken into consideration, the threads 111 of the coil 110 are subject to force F in an upward or downward direction as defined by Fleming's left-hand rule in a direction in which the electric current flows (i.e., a direction in which the electric current flows at a point through which the magnetic flux passes) as shown in FIG. 6. As a result, the total force summed in the upward or downward direction is applied to the coil 110 formed of the threads 111. However, since the coil 110 is fixed, the counteraction force of the summed force applied to the coil 110 is applied to the permanent magnet 120 relatively movable up and down and the vibration body 150 coupled with the permanent magnet 120. Accordingly, the permanent magnet 120 and the vibration body 150 coupled with the permanent magnet 120 are vibrated, thus generating a vibration shock.

### Second Exemplary Embodiment

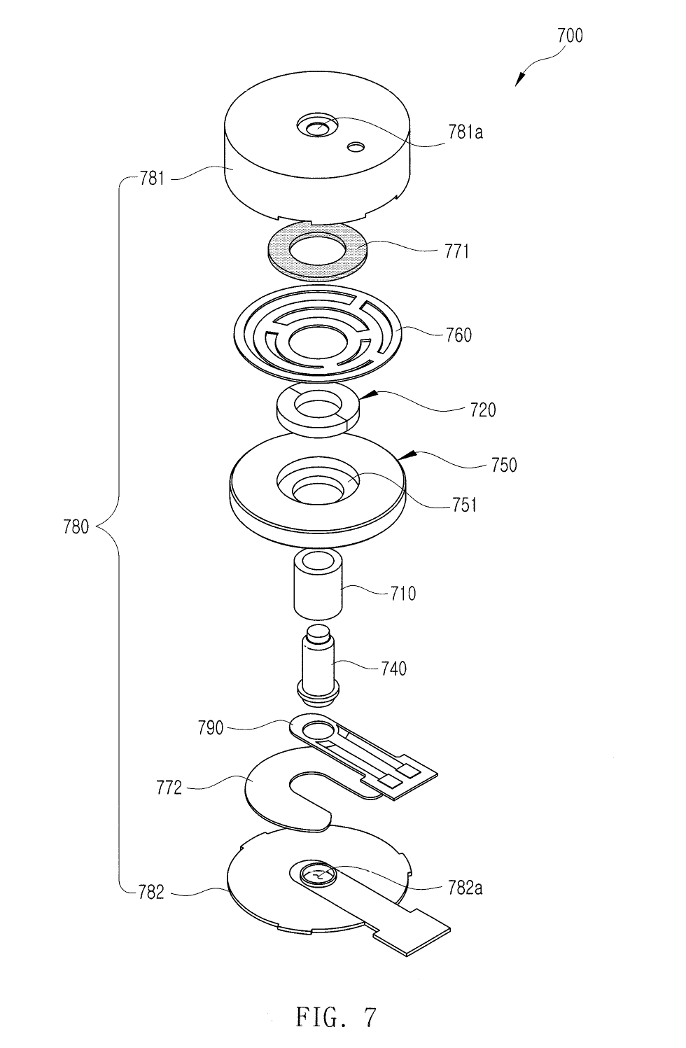

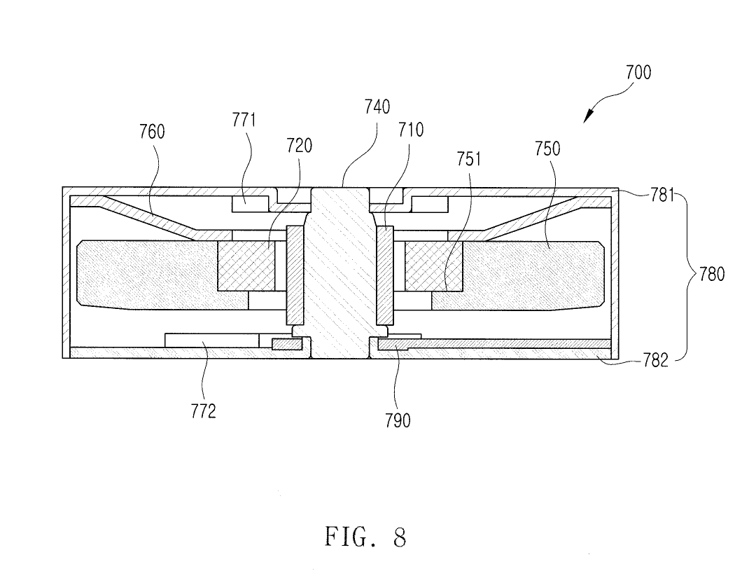

FIGS. 7 and 8 are a schematic exploded perspective view and schematic assembly cross-sectional view of a linear vibrator 700 according to a second exemplary embodiment of the present invention.

Referring to FIGS. 7 and 8, the linear vibrator 700 according to an exemplary embodiment of the present invention includes a coil 710, a permanent magnet 720, a polepiece 740, a vibration body 750, a spring 760, dampers 771 and 772, a casing 780, and a circuit board 790.

The coil 710 generates a magnetic flux in response to an electrical signal generated from the circuit board 790.

The permanent magnet 720 is configured in a ring shape having a hole formed in the center, and the coil 710 is inserted into the hole of the permanent magnet 720. Accordingly, the permanent magnet 720 is vibrated up and down in response to the magnetic flux generated from the coil 710. As in the first exemplary embodiment, the outside of the permanent magnet 720 configured to come into contact with the vibration body 750 and placed in a direction opposite to the inside of the permanent magnet 720 that faces the coil 710 and the inside of the permanent magnet 720 have different poles.

The polepiece 740 is inserted into the inside of the coil 710 in order to concentrate the magnetic flux of the permanent magnet 720 onto the inside of the coil 710. The polepiece 740 has the top fixed to the upper casing 781 and the bottom fixed to the lower casing 782.

The vibration body 750 is coupled with the outside of the permanent magnet 720 and is vibrated while operating in conjunction with the vibration of the permanent magnet 720, thus increasing a vibration mass. In an exemplary embodiment of the present invention, the vibration body 750 includes a support jaw 751 for supporting the bottom of the permanent magnet 720.

The spring 760 elastically supports the vibration body 750 that vibrates up and down. Furthermore, the edge of the inside of the spring 760 supports the top of the permanent magnet 720. Accordingly, the permanent magnet 720 can be fixed by the vibration body 750 and the spring 760 without an additional fixing body.

The dampers 771 and 772 are provided to prevent some of vibrating parts (i.e., the permanent magnet 720, the vibration body 750, and the spring 760) from directly coming into contact with the top or bottom of the casing 780.

The casing 780 includes a receiving space S for accommodating the coil 710, the permanent magnet 720, the polepiece 740, the vibration body 750, the spring 760, and the dampers 771 and 772. Furthermore, the casing 780 can be separated into an upper casing 781 and a lower casing 782 coupled with the upper casing 781. Here, a first fixing hole 781a into and to which the upper part of the polepiece 740 can be inserted and fixed is formed in the upper casing 781, and a second fixing hole 782a into and to which the lower part of the polepiece 740 can be inserted and fixed is formed in the lower casing 782. That is, the upper and lower parts of the polepiece 740 are inserted into the upper casing 781 and the lower casing 782 and fixed thereto, thereby being capable of improving durability.

The circuit board 790 is provided to input an electrical signal to the coil 710.

The present invention can have the following advantages.

First, since the magnetic flux of the permanent magnet is directed toward the coil, a magnetic flux that leaks without contributing to the vibration of the permanent magnet is minimized. Accordingly, efficiency can be improved and thus the size of a linear vibration can be further reduced.

Second, productivity can be improved because the permanent magnet is fixed by a simple structure.

Third, durability can be improved because a structure for fixing the polepiece is robust.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A linear vibrator, comprising:
a cylindrical coil provided in a central portion of the linear vibrator and configured to generate a magnetic flux in response to an electrical signal;
a permanent magnet configured in a ring shape in an outside of the coil and configured to vibrate in response to the magnetic flux generated from the coil;
a vibration body coupled with an outside of the permanent magnet and configured to vibrate while operating in conjunction with the vibration of the permanent magnet;
a casing configured to accommodate the coil, the permanent magnet, and the vibration body;
a circuit board configured to supply the electrical signal to the coil; and
a spring configured to elastically support the vibration body to the casing,
wherein an inside of the permanent magnet facing the coil and the outside of the permanent magnet coming into contact with the vibration body have different poles.

2. The linear vibrator of claim 1, further comprising a fixing body made of a non-magnetic material and configured to fix the permanent magnet to the vibration body.

3. The linear vibrator of claim 1, further comprising a polepiece inserted into an inside of the coil in order to concentrate the magnetic flux on the inside of the coil.

4. The linear vibrator of claim 1, wherein the permanent magnet is split into two or more pieces when being seen in a vibration direction of the permanent magnet.

5. The linear vibrator of claim 1, wherein:
the vibration body comprises a support jaw for supporting a first end of the permanent magnet, and
a second end of the permanent magnet is supported by the spring.

6. The linear vibrator of claim 1, wherein the casing comprises:
an upper casing; and
a lower casing coupled with the upper casing,
wherein a first fixing hole into and to which an upper part of the polepiece is inserted and fixed is formed in the upper casing, and
a second fixing hole into and to which a lower part of the polepiece is inserted and fixed is formed in the lower casing.

7. A linear vibrator, comprising:
a cylindrical coil provided in a central portion of the linear vibrator and configured to generate a magnetic flux in response to an electrical signal;
a permanent magnet configured in a ring shape in an outside of the coil and configured to vibrate in response to the magnetic flux generated from the coil;
a vibration body coupled with an outside of the permanent magnet and configured to vibrate while operating in conjunction with the vibration of the permanent magnet;
a casing configured to accommodate the coil, the permanent magnet, and the vibration body;
a circuit board configured to supply the electrical signal to the coil; and
a spring configured to elastically support the vibration body to the casing,
wherein the vibration body comprises a support jaw for supporting a first end of the permanent magnet, and a second end of the permanent magnet is supported by the spring.
